(19) United States
(12) Patent Application Publication
(10) Pub. No.: US 2020/0004375 A1
(43) Pub. Date: Jan. 2, 2020

(54) VISUAL INTERFACE SYSTEM

(71) Applicant: Slim HMI Technology, Taipei City (TW)

(72) Inventor: Hsiung-Kuang TSAI, Taipei City (TW)

(21) Appl. No.: 16/567,564

(22) Filed: Sep. 11, 2019

Related U.S. Application Data
(63) Continuation-in-part of application No. 15/488,965, filed on Apr. 17, 2017.
Application No. 15/488,965 is a continuation of application No. 14/344,462, filed on Mar. 12, 2014, now abandoned.

(51) Int. Cl. G06F 3/041; H04W 4/80; G06F 3/044; H04B 5/00

(52) U.S. Cl. CPC G06F 3/0416; H04W 4/80; G06F 3/0412; G06F 2203/04101; H04B 5/0031; G06F 3/041; G06F 3/044

(57) ABSTRACT

In visual interface system, a matrix display apparatus includes a matrix substrate, a controller and drivers. The controller receives and encodes a source data into an image data and a transmission data. The matrix substrate includes a substrate having a front surface and a back surface, pixel units formed on the back surface; and line electrodes intersected and formed on the back surface electrically connected to the pixel units to form a display matrix. The image data is through the line electrodes to the pixel units so that the matrix display apparatus presents an optical image, and the transmission data are to be coupled electrically from the display matrix and transmit wirelessly. An operation apparatus is operated on the front surface to receive the transmission data from the display matrix formed on the back surface by wirelessly coupling, and obtains the source data by decoding the transmission data.

### CROSS REFERENCE TO RELATED APPLICATIONS

The present application is a Continuation-In-Part application of U.S. application Ser. No. 15/488,965, which is a Continuation application of U.S. application Ser. No. 14/344,462, which is a 35 U.S.C. § 371 National Phase conversion of International (PCT) Patent Application No. PCT/CN2011/079576, filed on Sep. 13, 2011, the disclosure of which is incorporated by reference herein. The PCT International Patent Application was filed and published in Chinese.

### BACKGROUND OF THE INVENTION

### Field of Invention

The present disclosure relates to a human-machine interface system and, in particular, to a visual interface system.

### Related Art

Recently, touch panels have been widely applied to the commercial electronic products such as mobile phones, digital cameras, MP3, PDA, GPS, tablet PC, UMPC, and the likes. In these electronic products, the touch panel is bound with a screen to form a touch input display apparatus. A manufacturing method of a conventional touch input display apparatus is to dispose a touch panel on a display panel of a display module. However, due to the additional touch panel, this approach not only increases the weight and sized of the product, but also the cost.

In order to broaden the applications of the commercial electronic products, some products have been added with the new function of near field communication (NFC), which can be used to replace the conventional IC card (e.g. door card, credit card, ticket, and etc.), exchange information (e.g. music, image, name card, and etc.) between two electronic devices, or the likes. Accordingly, it is desired to create a product with a simple structure and more functions.

Therefore, it is an important subject to provide a visual interface system which can achieve the desired touch input function without configuring an additional touch panel, thereby making the product lighter and thinner, lowering the production cost, and providing the NFC function for broadening the application field.

### SUMMARY OF THE INVENTION

An objective of the present disclosure is to provide a visual interface system that can achieve the touch input function without configuring an additional touch panel, and is equipped with a near field communication (NFC) function.

The present disclosure can be implemented by the following technical proposals.

In one embodiment, a visual interface system includes a matrix display apparatus and an operation apparatus. The matrix display apparatus includes a matrix substrate, a controller and drivers. The controller is configured to receive and encode a source data into an image data and a transmission data. The matrix substrate including a substrate having a front surface and a back surface, pixel units formed on the back surface of the substrate; and line electrodes intersected and formed on the back surface of the substrate electrically connected to the pixel units to form a display matrix. The front surface faces a viewer watching images displayed on the matrix display apparatus, and the back surface faces away the viewer when the viewer is watching images displayed on the matrix display apparatus. The image data is through the line electrodes to the pixel units so that the matrix display apparatus presents an optical image, and the transmission data are to be coupled electrically from the display matrix and transmit wirelessly. The operation apparatus is configured to be operated on the front surface of the substrate to receive the transmission data from the display matrix formed on the back surface of the substrate by wirelessly coupling, and configured to obtain the source data by decoding the transmission data.

In one embodiment, the wireless transmission is capacitive coupling.

In one embodiment, the operation apparatus is configured to generate a transmission signal and transmit the transmission signal to the matrix display apparatus.

In one embodiment, the transmission signal comprises instruction information, identification information, transaction information or file information.

In one embodiment, the matrix display apparatus processes the transmission signal to obtain instruction information, identification information, transaction information, or file information.

In one embodiment, the operation apparatus is configured to generate and transmit a transmission signal, the system further includes at least a relay apparatus configured to receive and process the transmission signal to generate a relay processed signal.

In one embodiment, the relay processed signal is transmitted to the matrix display apparatus.

In one embodiment, the transmission signal or the relay processed signal comprises instruction information, identification information, transaction information, file information or other information.

In one embodiment, the matrix display apparatus processes the relay processed signal to generate instruction information, identification information, transaction information, or file information.

In one embodiment, the system further includes a mode trigger apparatus configured to enable the matrix display apparatus into an operating mode to output the transmission data as the mode trigger apparatus is triggered by a user or the operation apparatus.

In one embodiment, the matrix display apparatus comprises a receiver, the transmission data is transmitted from the display matrix through a user to the receiver.

In one embodiment, the receiver has a mode trigger function, so the receiver enables the matrix display apparatus to an operating mode to output the transmission data when user activates the receiver.

In one embodiment, the transmission data comprises a time-reference point signal.

In one embodiment, the controller or the driver is configured to provide display signals to the line electrodes to control the pixel units for displaying images, and the transmission data has a frequency higher than the display signals and adds directly on the display data signal.

As mentioned above, the visual interface system of the disclosure can be directly applied to the system containing matrix structure such as TFT LCD panel, OLED panel, LED panel, electrophoretic display panel, MEMS display panel, or the likes, thereby integrating display, touch input and data transmission functions together. Thus, the manufactured products can be lighter and thinner and the product cost can be decreased, thereby improving the product competitiveness. Moreover, the encoded signal is coupled to the external operation apparatus instead of being directly read by the matrix substrate, so that it is unnecessary to modify the layout on the matrix substrate. For example, regarding the touch input application, it is unnecessary to add the capacitance sensing components in the display panel for detecting the change of external capacitance values. As a result, the present disclosure can decrease the manufacturing cost and shrink the process time.

### BRIEF DESCRIPTION OF THE DRAWINGS

The invention will become more fully understood from the detailed description and accompanying drawings, which are given for illustration only, and thus are not limitative of the present disclosure, and wherein:

FIG. 1 is a block diagram of a visual interface system according to a first embodiment of the disclosure;

FIG. 2 is a side view of a matrix display apparatus according to the first embodiment of the disclosure;

FIG. 3 is a schematic diagram showing a TFT substrate used in the first embodiment of the disclosure;

FIG. 4 is a schematic diagram showing the signals for two row electrodes and two column electrodes of the TFT substrate of FIG. 3;

FIG. 5 is a timing chart of the encoded signal transmitted through each column electrode according to the first embodiment of the disclosure;

FIG. 6 is a perspective view of the matrix display apparatus of the visual interface system according to the first embodiment of the disclosure;

FIG. 7 is a schematic diagram showing the matrix display apparatus and a user, as the operation apparatus, of the visual interface system according to the first embodiment of the disclosure; and

FIG. 8 is a block diagram of a visual interface system according to a second embodiment of the disclosure.

### DETAILED DESCRIPTION OF THE INVENTION

The present invention will be apparent from the following detailed description, which proceeds with reference to the accompanying drawings, wherein the same references relate to the same elements.

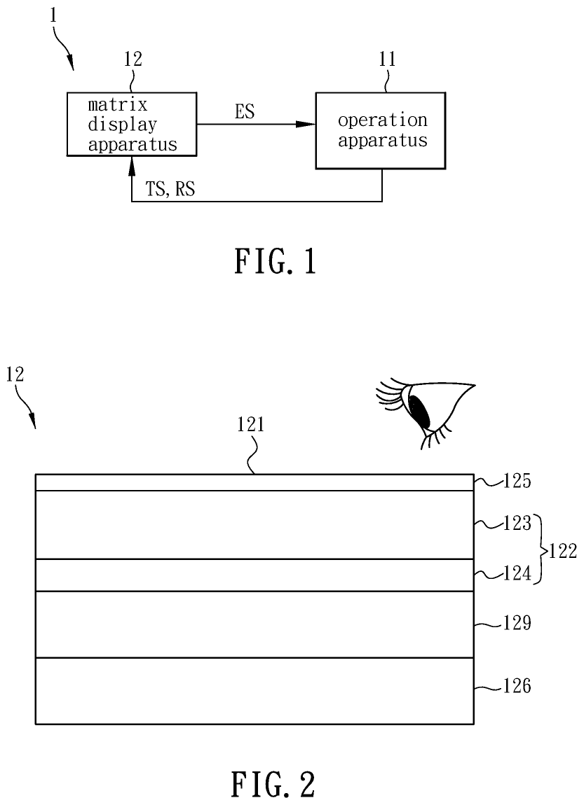

FIG. 1 is a block diagram of a visual interface system 1 according to a first embodiment of the disclosure. The visual interface system 1 includes an operation apparatus 11 and a matrix display apparatus 12, which are coupled with each other. For example, the operation apparatus 11 is capacitive coupled to the matrix display apparatus 12 for transmitting signals, which is a non-contact signal transmission.

In this embodiment, the operation apparatus 11 is, for example, a stylus, an IC card, an NFC reading apparatus, or a user (especially the hand of a user). When the operation apparatus 11 is an electronic apparatus, it may include some functional circuits such as a process control circuit, a storage circuit or a transmission circuit. Herein, any circuit can be composed of hardware, software or firmware, or their combinations. We can regard user as an operation apparatus 11, which means user can serve as a conductor for transmitting signals. In this case, the input and output signals are substantially equivalent as input connects to output through a conductor.

FIG. 2 is a side view of the matrix display apparatus 12. As shown in FIG. 2, the matrix display apparatus 12 includes a display surface 121 and a matrix substrate 122. The matrix substrate 122 includes a substrate 123 and a matrix 124. The matrix 124 is disposed at one side of the substrate 123, while the display surface 121 is located at the other side of the substrate 123. In this embodiment, the display surface 121 is the surface of the matrix display apparatus 12, which is closest to the viewer when the viewer is watching the images displayed on the matrix display apparatus 12. Besides, the matrix display apparatus 12 may further include a protect glass 125 disposed on one side of the substrate 123 opposite to the matrix 124. In this case, the display surface 121 is the surface of the protect glass closest to the viewer. Moreover, one side of the substrate 123 close to the protect glass 125 may be further configured with other components such as a polarizer, frame, or the likes. In view of an LCD display, there are liquid crystal 129, color filter substrate 126 (shown in FIG. 2) and backlight unit (not shown). Compared to present LCD panel, the matrix display apparatus 12 is to arrange the panel in an upside down configuration, i.e., TFT substrate 123 is close to the viewer than the color filter substrate 126.

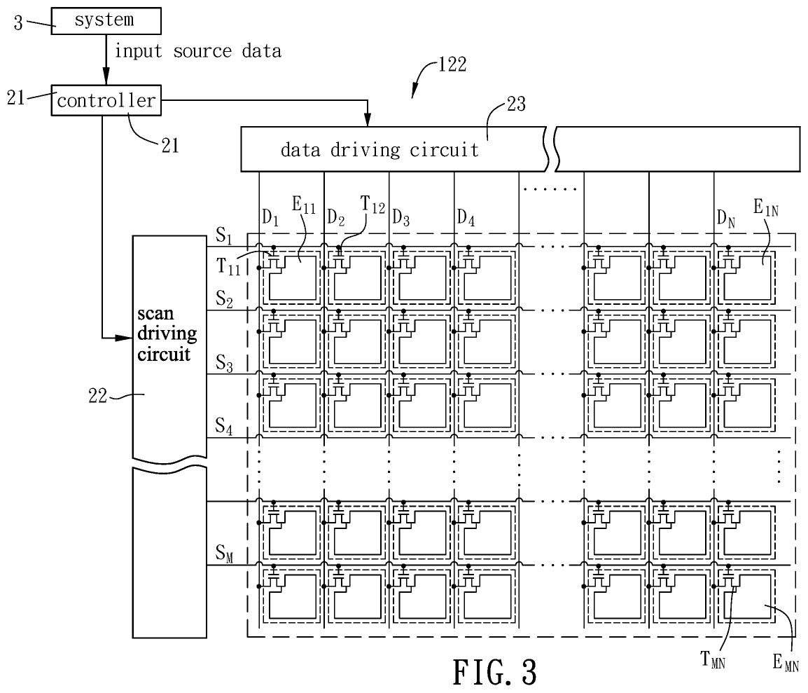

In this embodiment, the matrix substrate 122 is a substrate configured with pixel matrix for displaying images, for example the TFT substrate of LCD panel, OLED panel, LED panel, electrophoretic panel, MEMS display panel, and the likes. In FIG. 2, the matrix substrate 122 is the TFT substrate of LCD panel for example. The TFT substrate 123 has a front surface (as the display surface 121) and a back surface, pixel units formed on the back surface of the TFT substrate 123; and line electrodes intersected and formed on the back surface of the TFT substrate 123 electrically connected to the pixel units to form a display matrix. The front surface faces a viewer watching images displayed on the matrix display apparatus 12, and the back surface faces away the viewer when the viewer is watching images displayed on the matrix display apparatus 12. The matrix 124 includes a plurality of row electrodes, a plurality of column electrodes, and a plurality of pixel electrodes, wherein the row electrodes and the column electrodes are intersected and formed on the TFT substrate 123. Moreover, the matrix 124 can be an active matrix or a passive matrix. In this embodiment, the matrix 124 is an active matrix for example. Besides, the matrix 124 may further include a plurality of transistors electrically connected with the row electrodes, the column electrodes and the pixel electrodes, respectively. The transistors, the row electrodes, the column electrodes and the pixel electrodes (shown in FIG. 3) are formed on the TFT substrate 123 and located above the liquid crystal 129.

The implementation of the embodiment used in the touch input purpose will be described hereinafter. Referring to FIGS. 1 and 2, when the operation apparatus 11 is operated on the display surface 121, an encoded signal ES is coupled to the operation apparatus 11 from the matrix substrate 122, and the operation apparatus 11 receives the encoded signal ES so as to generate a transmission signal TS. Herein, the encoded signal ES contains the coordinates of the display screen of the matrix display apparatus 12, and the transmission signal TS contains the coordinate information. When the encoded signal ES is transmitted form the matrix substrate 122 to the operation apparatus 11, they are wirelessly coupled so as to form a near field signal transmission. Of course, in other applications, the encoded signal can be composed of any information to be transmitted such as touch input information, instruction information, identification information, transaction information, or file information (e.g. music, images, texts, and etc.), so that the transmission signal TS contains the corresponding information.

The encoded signal ES is applied to the matrix substrate 122, and additional display signals are applied to the matrix substrate 122 for displaying images. The encoded signal ES is applied during the blanking time of the display signals. For example, the encoded signal ES can be applied between two frames or scan operations of two row electrodes, or during the gap generated as shortening the input time of the display signals. Or, the encoded signal ES can have a higher frequency and be directly added on the display signals.

The encoded signal ES and the transmission signal TS will be further described hereinbelow, wherein the matrix substrate 122 is a TFT substrate of an LCD apparatus.

FIG. 3 is a schematic diagram showing a TFT substrate and the control/driving circuits used in this embodiment. A controller 21 connects to data and scan drivers (scan driving circuit 22 and data driving circuit 23) and these drivers further connect to the TFT matrix as in an LCD apparatus. The controller 21 receives an input source data from a system 3 and converts it into image data and transmission data. These data send to data/scan drivers and then the TFT matrix. The image data will become display signals to drive the matrix and lead to an image from the matrix display apparatus 12. The transmission data becomes encoded signal ES to be coupled wireless from the matrix. The system 3 may be a computing unit which has a communication port and outputs digital data at the communication port. The computing unit may be a controller, a component of a computing device, a remote computing device, etc. The matrix display apparatus 12 can be included in the computing device. The controller 21 may have at least a communication port connected to the system 3 to receive the input source data. The communication port may be a port for UART, LVDS, display port, RS232, USB etc. The input source data may include image source data and transmission source data. The transmission source data may be digital data containing application information, for example instruction information, identification information, transaction information, or file information. For example, the transmission source data is not to handle the communication between the system 3 and the controller 21 and not to handle the displaying image of the display matrix, but contains application information which the system 3 wants to send to the operation apparatus 11. The transmission source data does not exist in conventional T-con circuit. The image source data includes image data and its control data like data which conventional T-con circuit receives and handles. Referring to FIGS. 2 and 3, the matrix 124 includes a plurality of row electrodes S₁˜S_{M}, a plurality of column electrodes D₁˜D_{N}, and a plurality of pixel electrodes E₁₁˜E_{MN}. The row electrodes and the column electrodes are intersected and they are substantially perpendicular to each other or have an included angle. Moreover, the matrix 124 further includes a plurality of transistors for electrically connected with the row electrodes S₁˜S_{M}, column electrodes D₁˜D_{N}, and pixel electrodes E₁₁˜E_{MN}. The row electrodes S₁˜S_{M} are referred to scan lines, while the column electrodes D₁˜D_{N} are referred to data lines. Besides, the substrate 123 may further be configured with a driving module, which includes data driving circuit, scan driving circuit, timing control circuit (not shown), and gamma calibration circuit (not shown), for driving the LCD panel to display images. Since the function of the driving module is well known in this art, the detailed description thereof will be omitted here. To be noted, the above-mentioned matrix substrate is for illustrations only and is not to limit the disclosure. The point of this embodiment is that the encoded signal is transmitted from the matrix substrate to the operation apparatus through the row electrodes S₁˜S_{M} and/or the column electrodes D₁˜D_{N} so as to generate the transmission signal. The encoded signal may contain various information for different applications such as the reference coordinates of the display screen, the file information of different formats (e.g. personal data, music, images, and etc.), and the likes.

In this embodiment, the column electrodes D₁˜D_{N} can transmit not only the data signals for displaying images but also the encoded signal. For example, the display signal can be directly added to the encoded signal with higher frequency or be added to the blank period of the displayed data signal such as the period after the scan procedure of all row electrodes S₁˜S_{M} are finished and before the next scan procedure start (the blank period between frames). Or, the display signal can be inserted after one row electrode is scanned and before the scan of next row electrode, or within the scan period of row electrode by reducing the display data signal period and before sending the display data. Herein, the encoded signal can be provided by expending T-con circuit function and data or scan driving circuit, thereby simplifying the circuit design.

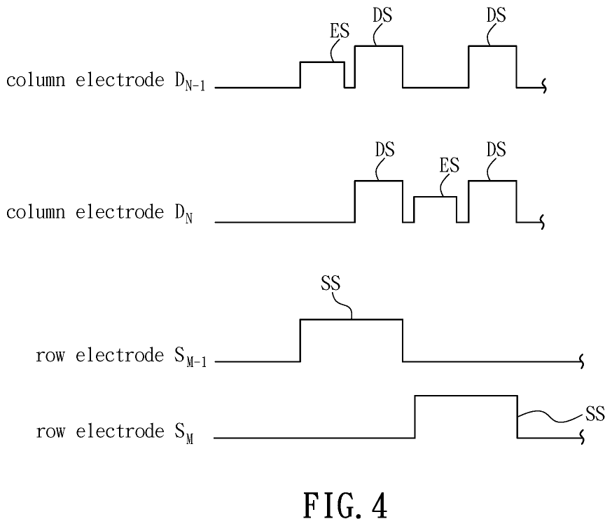

FIG. 4 is a schematic diagram showing the signals for two adjacent row electrodes and two adjacent column electrodes. The row electrodes S₁˜S_{M} transmit the scan signals SS, respectively, for sequentially turning on the transistors of each column. During the period that the transistors of each column are turned on, each of the column electrodes D₁˜D_{N} respectively transmits the corresponding encoded signal ES and the displayed data signal DS. The encoded signal ES will be described hereinafter by taking one dimension touch input perpendicular to the row electrode and sequentially encoded in time as an example. Of course, this method can also be applied to another dimension touch input perpendicular to the column electrode. Consequently, a complete two-dimensional touch input can be built. In this embodiment, as shown in FIG. 4, only one column electrode transmits the encoded signal ES when one row electrode transmits the scan signal. In this figure, the encoded signal ES is labeled with a level different from that of the displayed data signal DS; or, in practice, the encoded signal ES and the displayed data signal DS may have the same level.

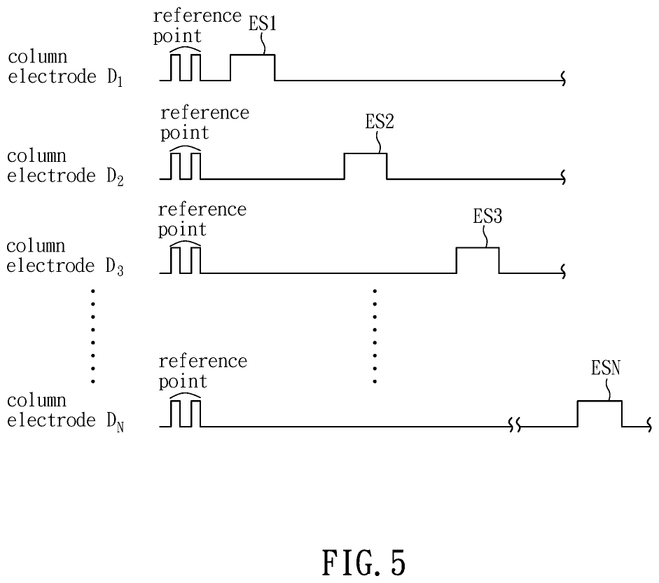

FIG. 5 is a timing chart of the encoded signal transmitted through each column electrode, wherein the data signals for display are omitted. When the row electrodes transmit the scan signals, the column electrodes D₁˜D_{N} transmit the encoded signals ES1˜ESN, respectively. To be noted, the encoded signals can be transmitted through different column electrodes, respectively, or multiple column electrodes may transmit the same encoded signal. For example, the column electrodes D₁˜D₃ transmit the encoded signal ES1. This approach may also be applied to the transmission of encoded signals through the row electrodes. Alternatively, the encoded signals transmitted through the row electrodes and the column electrodes may be independent. Since the column electrodes transmit the encoded signals ES, respectively, it is necessary to provide a time reference point for determining the positions of the column electrodes by comparing with the reference point. This reference point can be a specific code and transmitted by the same manner. For example, all column electrodes may output the code “1” twice and then transmit the sequential signal. As mentioned above, if the encoded signal coupled to the operation apparatus is “110010000”, it represents that the operation apparatus is located on the third column electrode, thereby figuring out the coordinate (x-coordinate) of the operation apparatus. Similarly, the y-coordinate of the operation apparatus can be estimated according to another encoded signal applied to the row electrode. Since the scan signals from the row electrodes for driving the display signal are sequentially generated, they can also be used as the encoded signals of the row electrodes. The encoded signals of the row electrodes and the column electrodes may have a common reference point such as the horizontal or vertical sync signals for displaying images. Of course, the column electrodes D₁˜D_{N} and the row electrodes S₁˜S_{M} may have more complicated encoded signals, which will not be described in detail here.

The duty cycle of the encoded signal of this embodiment is smaller than that of the data signals so as to maintain the display quality.

When a user grabs the operation apparatus 11 and operates it on the display surface 121 of the matrix display apparatus 12 (e.g. to contact or approach the display surface), the encoded signal is capacitive coupled from the matrix substrate 122 to the operation apparatus 11. This embodiment takes the column electrodes D₁˜D_{N} for transmitting the encoded signals ES for an example, so the column electrode can serve as one of the capacitive coupling electrodes, and the operation apparatus 11 has the other capacitive coupling electrode. For example, when the operation apparatus 11 is a stylus, a conductor configured at the tip of the stylus functions as the other capacitive coupling electrode.

After receiving the encoded signal ES through the capacitive coupling, the operation apparatus 11 processes the received encoded signal ES to generate a transmission signal TS. This process includes amplifying and/or decoding the encoded signal ES so as to determine the touch position, the touch gesture (writing style), the corresponding function instruction, or which column electrode is touched or pressed. To be noted, the encoded signal ES is capacitive coupled to the operation apparatus 11, and the value of the capacitance relies upon the distance between the operation apparatus and the display surface, which means the amplitude of the signal can provide the z-axis information, so that the operation apparatus 11 can get not only the two-dimensional coordinates but also the z coordinate. Accordingly, the transmission signal TS stands for the result of processing the encoded signal ES, ranging from simple amplification to extract the information like commands of action.

After generating the transmission signal TS, the operation apparatus 11 can transmit the transmission signal TS to the matrix display apparatus 12, other relay apparatus, or other apparatuses outside the visual interface system through wire/wireless electrical coupling (including capacitive coupling) or optical coupling. In this embodiment, the transmission signal TS is directly transmitted to the matrix display apparatus 12.

When this disclosure is applied to other non-touch input applications, the information to be transmitted (transmission data) is encoded to generate an encoded signal ES based on a specific coding rule, and then the encoded signal ES is capacitive coupled from the matrix substrate 122 (e.g. configured as a cell phone or tablet computer) to the operation apparatus 11 (e.g. short distance wireless reading apparatus attached on the wall). Similarly, the operation apparatus 11 can process (decodes or modifies) the encoded signal ES based on the preset coding rule so as to obtain the transmission signal TS, and then uses the transmission signal TS on the corresponding application such as access control, payment, financial transaction, file transmission, and the likes.

In the above, the operation apparatus 11 processes the encoded signal ES to obtain the information contained in the transmission signal TS such as the touch input information, instruction information, identification information, transaction information, file information or other information. In other embodiments, the matrix display apparatus 12 may process the transmission signal TS to obtain an information signal, which contains the touch input information, instruction information, identification information, transaction information, file information or other information. In this case, the information signal, instead of the transmission signal TS, carries the complete information.

As mentioned above, referring to FIG. 1, in the procedures of coupling the encoded signal ES to the operation apparatus 11 to generate the transmission signal TS and transmitting the transmission signal TS to the matrix display apparatus 12 to obtain the information signal, the signal is processed by, for example, amplification and decoding, which can be handled by either the operation apparatus 11 or the matrix display apparatus 12. Accordingly, the resulting transmission signal TS or the information signal can contain the touch input information, instruction information, identification information, transaction information, file information or other information.

Besides, a response signal RS can also be transmitted between the operation apparatus 11 and the matrix display apparatus 12. Herein, the response signal RS is for providing the information of the receiving status of the operation apparatus 11 to the matrix display apparatus 12, announcing the operation apparatus 11 to get ready for receiving the signal, or synchronizing the operation apparatus 11 and the matrix display apparatus 12. This configuration can create an interactive mechanism between the transmitting and receiving signals. Moreover, the response signal RS can provide the synchronization function for establishing an information handshaking procedure between the operation apparatus 11 and the matrix display apparatus 12.

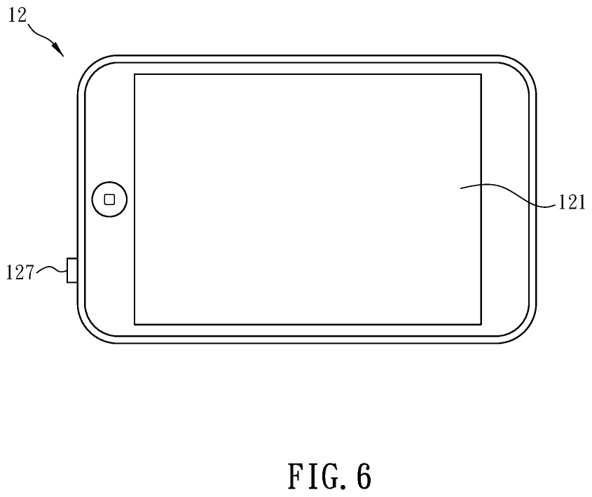

FIG. 6 is a schematic drawing of the matrix display apparatus 12 of the visual interface system according to the first embodiment of the disclosure. Referring to FIG. 6, the visual interface system further includes a mode trigger apparatus 127. When a user or the operation apparatus triggers the mode trigger apparatus 127, the mode trigger apparatus 127 can enable the matrix display apparatus 12 into an operating mode to output the encoded signal ES. For example, when the user needs the touch input function, he/she activates the mode trigger apparatus 127 so as to enable the matrix display apparatus 12 into the touch input mode. Then, the row electrode or column electrode starts to transmit the encoded signal ES. Otherwise, the matrix display apparatus 12 does not enter the touch input mode and the touch input function of the matrix display apparatus 12 may be partially or totally shut down. This function can save power and prevent the abnormal operation caused by unintentionally contacting the screen. To be noted, the operation of the mode trigger apparatus 127 may have different operation modes. For example, after being activated, the mode trigger apparatus 127 may remain in the new state for a while and then return to the original state, or it may change the state while been activated each time, or it remains in the new state only when the activation lasts. The mode trigger apparatus 127 can be configured on the operation apparatus (e.g. a switch on the stylus) as well. In this case, when the mode trigger apparatus 127 is activated, the operation apparatus 11 transmits a trigger signal to the matrix display apparatus 12 to control it to enter the touch input mode. To be noted, it is possible to switch to touch input function when the mode trigger apparatus 127 is activated once by the user or requests the user to keep activating the mode trigger apparatus 127 to maintain in touch input function. Taking the access card, ticket, credit card or file transmission as examples, the user can trigger the mode trigger apparatus to transmit the encoded signal (transmission data) to the corresponding data receiving device for authorizing personal identification. The mode trigger apparatus 127 can be, for example, a mechanical switch, a touch sensing switch, or the likes.

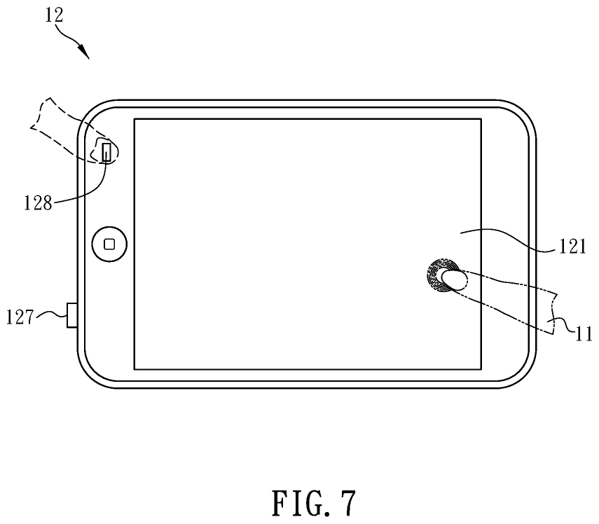

FIG. 7 is a schematic diagram showing the matrix display apparatus 12 and a user, as the operation apparatus 11, of the visual interface system 1 according to the first embodiment of the disclosure. In this aspect, the visual interface system 1 further includes a receiver 128, which is electrically coupled with the matrix display apparatus 12. When the user touches or approaches the display surface 121 and the receiver 128 of the matrix display apparatus 12 simultaneously, the encoded signal ES becomes transmission signal TS and is transmitted from matrix through user to the receiver 128. The user serves as a large conductor for transmitting the encoded signal ES as transmission signal TS to the matrix display apparatus 12. In practice, the user can use his/her right hand to operate on the display surface 121, while use the left hand to press the receiver 128. Accordingly, the encoded signal ES can enter the user body through the right hand, and the transmission signal TS can be outputted from the left hand. The receiver 128 may also contain the function of the mode trigger apparatus 127. For example, only when the receiver 128 is pressed by hand, the operation mode will be enabled. This specific function can sufficiently reduce the power consumption and problem of unintentional touch.

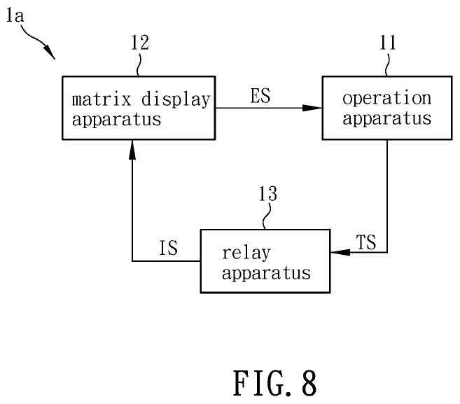

FIG. 8 is a block diagram of a visual interface system la according to a second embodiment of the disclosure. The visual interface system la includes an operation apparatus 11 and a matrix display apparatus 12. Different from the first embodiment, the visual interface system la further includes at least one relay apparatus 13, and the transmission signal TS is transmitted to the matrix display apparatus 12 or other apparatuses outside the visual interface system through the relay apparatus 13. Transmitting the transmission signal TS through user's hand to a relay apparatus 13 will be used to describe the implementation of this embodiment. From the transmission signal TS, the relay apparatus 13 generates a relay processed signal IS and transmits back to the matrix display apparatus 12. The relay apparatus 13 is only for illustration and it is possible to configure multiple relay apparatuses. When the operation apparatus 11 is a user, the user can transmit the transmission signal TS to the relay apparatus 13 instead of transmitting back to the matrix display apparatus 12. Herein, the relay apparatus 13 can be a portable communication device such as a cell phone. Accordingly, the user can be the transmission media for conducting the encoded signal ES outputted from the matrix display apparatus 12 to the relay apparatus 13 for the purpose of transmitting file information.

The relay apparatus 13 can process the transmission signal TS to generate a relay processed signal IS and then transmit the relay processed signal IS to the matrix display apparatus 12. In the procedures of coupling the encoded signal ES to the operation apparatus 11 to generate the transmission signal TS, processing the transmission signal TS by the relay apparatus 13 to generate the relay processed signal IS, and transmitting the relay processed signal IS to the matrix display apparatus 12 to obtain the information signal, the signal is processed by means, for example, amplification, decoding, modifying and/or interpretation, which can be implemented by all or either one of the operation apparatus 11, the matrix display apparatus 12 and the relay apparatus 13. Accordingly, the transmission signal TS, the relay processed signal IS or the information signal can contain the touch input information, instruction information, identification information, transaction information, file information or other information.

Besides, the response signal RS of the first embodiment can also be applied to the operation apparatus, relay apparatus and/or matrix display apparatus of the second embodiment, thereby creating an interactive mechanism between the transmitting and receiving signals. Moreover, the response signal RS can provide the synchronization function for establishing an information handshaking procedure between the operation apparatus, relay apparatus and matrix display apparatus.

In the visual interface system of the disclosure, when the operation apparatus is operated on the display surface, the encoded signal is coupled to the operation apparatus from the matrix substrate, and the operation apparatus receives the encoded signal to generate a transmission signal. In touch input application, the transmission signal can be directly or indirectly transmitted to the matrix display apparatus. During this transmission procedure, the transmission signal can be processed by operation apparatus, at least one relay apparatus, and/or the matrix display apparatus, so that the matrix display apparatus can retrieve the information contained in the encoded signal and transmission signal, such as touch input information, instruction information, identification information, transaction information, file information or other information.

As mentioned above, the visual interface system of the disclosure can be directly applied to the system containing matrix structure such as TFT LCD panel, OLED panel, LED panel, electrophoretic display panel, MEMS display panel, or the likes, thereby integrating display, touch input and data transmission functions together. Thus, the products can be lighter and thinner and the product cost can be decreased, thereby improving the product competitiveness. Moreover, the encoded signal is coupled to the external operation apparatus instead of being directly read by the matrix substrate, so that it is unnecessary to modify the layout on the matrix substrate. For example, regarding to the touch input application, it is unnecessary to add the capacitance sensing component in the display panel for detecting the change of external capacitance values. As a result, the present disclosure can decrease the manufacturing cost and time.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A visual interface system, comprising:
a matrix display apparatus, comprising:
a controller and drivers, the controller configured to receive and encode a source data into an image data and a transmission data; and
a matrix substrate including:
a substrate, having a front surface and a back surface, wherein the front surface faces a viewer watching images displayed on the matrix display apparatus, and the back surface faces away the viewer when the viewer is watching images displayed on the matrix display apparatus;
a plurality of pixel units, formed on the back surface of the substrate; and
a plurality of line electrodes intersected and formed on the back surface of the substrate, electrically connected to the pixel units to form a display matrix, wherein the image data is through the line electrodes to the pixel units so that the matrix display apparatus presents an optical image, and the transmission data are to be coupled electrically from the display matrix and transmit wirelessly; and
an operation apparatus, configured to be operated on the front surface of the substrate to receive the transmission data from the display matrix formed on the back surface of the substrate by wirelessly coupling, and configured to obtain the source data by decoding the transmission data.

2. The visual interface system of claim 1, wherein the wireless transmission is capacitive coupling.

3. The visual interface system of claim 1, wherein the operation apparatus is configured to generate a transmission signal and transmit the transmission signal to the matrix display apparatus.

4. The visual interface system of claim 3, wherein the transmission signal comprises instruction information, identification information, transaction information or file information.

5. The visual interface system of claim 3, wherein the matrix display apparatus processes the transmission signal to obtain instruction information, identification information, transaction information, or file information.

6. The visual interface system of claim 1, wherein the operation apparatus is configured to generate and transmit a transmission signal, the system further comprises:
at least a relay apparatus configured to receive and process the transmission signal to generate a relay processed signal.

7. The visual interface system of claim 6, wherein the relay processed signal is transmitted to the matrix display apparatus.

8. The visual interface system of claim 6, wherein the transmission signal or the relay processed signal comprises instruction information, identification information, transaction information, file information or other information.

9. The visual interface system of claim 7, wherein the matrix display apparatus processes the relay processed signal to generate instruction information, identification information, transaction information, or file information.

10. The visual interface system of claim 1, further comprising:
a mode trigger apparatus configured to enable the matrix display apparatus into an operating mode to output the transmission data as the mode trigger apparatus is triggered by a user or the operation apparatus.

11. The visual interface system of claim 1, wherein the matrix display apparatus comprises a receiver, the transmission data is transmitted from the display matrix through a user to the receiver.

12. The visual interface system of claim 11, wherein the receiver has a mode trigger function, so the receiver enables the matrix display apparatus to an operating mode to output the transmission data when user activates the receiver.

13. The visual interface system of claim 1, wherein the transmission data comprises a time-reference point signal.

14. The visual interface system of claim 1, wherein the controller or the driver is configured to provide display signals to the line electrodes to control the pixel units for displaying images, and the transmission data has a frequency higher than the display signals and adds directly on the display data signal.
